(19) United States
(12) Patent Application Publication
(10) Pub. No.: US 2022/0269642 A1
(43) Pub. Date: Aug. 25, 2022

(54) METHOD AND APPARATUS FOR ELIMINATING GLITCH, AND STATE MACHINE

(71) Applicant: GREE ELECTRIC APPLIANCES, INC. OF ZHUHAI, Qianshan Zhuhai City (CN)

(72) Inventors: Chenghui ZOU, Zhuhai (CN); Feiyang DENG, Zhuhai (CN); Zhenxing PAN, Zhuhai (CN); Yuqing NIE, Zhuhai (CN)

(73) Assignee: GREE ELECTRIC APPLIANCES, INC. OF ZHUHAI, Qianshan Zhuhai City (CN)

(21) Appl. No.: 17/625,524

(22) PCT Filed: Jun. 29, 2020
(86) PCT No.: PCT/CN2020/098669

§ 371 Date: Jan. 7, 2022

(30) Foreign Application Priority Data
Sep. 4, 2019 (CN) 201910830595.6

(51) Int. Cl. G06F 13/42; H04L 7/00

(52) U.S. Cl. CPC G06F 13/4291; H04L 7/0008

(57) ABSTRACT

Disclosed are a method and an apparatus for eliminating a glitch, and a state machine, which are used for improving the accuracy of data transmission. The method includes: acquiring a transmission instruction of to-be-transmitted data, the transmission instruction at least carry the data; when it is determined that a first slave state machine can transmit the data, transmitting the to-be-transmitted data to the first state according to the transmission instruction; transferring the data according to a preset transfer state; when it is determined that a clock cycle for transmitting the data reaches a preset clock cycle, transferring the to-be-transmitted data to a preset state; and when it is determined that a preset transmission time is reached, transmitting the data.

### CROSS REFERENCES TO RELATED APPLICATION

This application is a National Stage of International Application No. PCT/CN2020/098669, filed Jun. 29, 2020, which claims priority to Chinese patent application No. 201910830595.6, titled “ Method and Apparatus for Eliminating Glitch, and State Machine”, and filed on Sep. 4, 2019, the contents of which are hereby incorporated by reference in their entirety.

### TECHNICAL FIELD

The present disclosure relates to the field of the communication technology, and particularly to a method and an apparatus for eliminating a glitch, and a state machine.

### BACKGROUND

At present, because the I2C (Inter Integrated Circuit) bus can achieve advantages such as fewer interfaces, a high communication efficiency, and simple operation when used, it is still widely used in the fields such as small-capacity storage and low-speed communication control.

However, when using the I2C bus to transmit data, abrupt peaks, i.e., glitches will appear on the transmission bus, resulting in inaccurate transmission of the transmitted data. In related technologies, filters are generally provided at the receiving end of the transmitted data to filter the glitches.

### SUMMARY

The embodiments of the present disclosure provide a method and an apparatus for eliminating a glitch, and a state machine, to improve the accuracy of the data transmission.

In the first aspect, a method for eliminating a glitch is provided, which is applied to an I2C bus, and the method includes:
acquiring a transmission instruction of to-be-transmitted data, wherein the transmission instruction at least carries the to-be-transmitted data;
transmitting the to-be-transmitted data to a first state according to the transmission instruction when determining a first slave state machine to transmit the to-be-transmitted data;
transferring the to-be-transmitted data according to a preset transfer state; the preset transfer state at least comprises a completed state of a transmission of a storage address of the to-be-transmitted data, and a read state of the to-be-transmitted data;
transferring the to-be-transmitted data to a preset state when determining that a clock cycle for transmitting the to-be-transmitted data reaches a preset clock cycle, the preset state being a state of suspended data transmission, and transmitting the to-be-transmitted data when determining that preset transmission time is reached.

In an optional embodiment, the transmitting the to-be-transmitted data to the first state according to the transmission instruction when determining the first slave state machine to transmit the to-be-transmitted data includes:
when the transmission instruction is determined to comprise indication information indicating the first slave state machine to transmit the to-be-transmitted data, determining the indicated first slave state machine from at least one slave state machine according to the indication information to transmit the to-be-transmitted data to the first state.

In an optional embodiment, the transmitting the to-be-transmitted data to the first state according to the transmission instruction when determining the first slave state machine to transmit the to-be-transmitted data includes:
determining at least one slave state machine to transmit the to-be-transmitted data;
transmitting the to-be-transmitted data to the first state when determining the first slave state machine from the at least one slave state machine to transmit the to-be-transmitted data.

In an optional embodiment, when the to-be-transmitted data cannot be transmitted by the at least one slave state machine, taking the to-be-transmitted data as next to-be-transmitted data or discarded data.

In an optional embodiment, the transferring the to-be-transmitted data according to the preset transfer state includes:
determine whether a control signal is received when determining that the to-be-transmitted data is transmitted to the first state;
transferring the to-be-transmitted data to the preset state when determining that the control signal is received.

In an optional embodiment, when determining that no control signal is received, reading address information of the to-be-transmitted data, and transmitting the to-be-transmitted data to a to-be-transmitted state.

In an optional embodiment, a coding mode of the first slave state machine is a gray_code coding mode.

In the second aspect, an apparatus for eliminating a glitch is provided, which is applied to an I2C bus, the apparatus includes:
an acquisition module, configured to acquire a transmission instruction of to-be-transmitted data; the transmission instruction at least carries the to-be-transmitted data;
a first determination module, configured to transmit the to-be-transmitted data to a first state according to the transmission instruction when determining the first slave state machine to transmit the to-be-transmitted data;
a second determination module, configured to transfer the to-be-transmitted data according to a preset transfer state; the preset transfer state at least comprises a completed state of a transmission of a storage address of the to-be-transmitted data, and a read state of the to-be-transmitted data;
a processing module, configured to transfer the to-be-transmitted data to the preset state when determining that a clock cycle for transmitting the to-be-transmitted data reaches a preset clock cycle, the preset state being a state of suspended data transmission, and transmit the to-be-transmitted data when determining that preset transmission time is reached.

In an optional embodiment, the first determination module is configured to:
when the transmission instruction is determined to comprise indication information indicating a first slave state machine to transmit the to-be-transmitted data, determine the indicated first slave state machine from at least one slave state machine according to the indication information to transmit the to-be-transmitted data to the first state.

In an optional embodiment, the first determination module is configured to:
determine at least one slave state machine to transmit the to-be-transmitted data;
transmit the to-be-transmitted data to the first state when the first slave state machine is determined from the at least one slave state machine to transmit the to-be-transmitted data.

In an optional embodiment, when the to-be-transmitted data cannot be transmitted by the at least one slave state machine, the to-be-transmitted data is taken as next to-be-transmitted data or discarded data.

In an optional embodiment, the second determination module is configured to:
determine whether a control signal is received when determining that the to-be-transmitted data is transmitted to the first state by the slave state machine;
transfer the to-be-transmitted data to a state of the determined clock cycle when determining that the control signal is received.

In an optional embodiment, when determining that no control signal is received, address information of the to-be-transmitted data is read, and the to-be-transmitted data is transmitted to a state of suspended processing.

In an optional embodiment, the coding mode of the first slave state machine is a gray_code coding mode.

In the third aspect, a state machine is provided, which includes:
a memory, configured to store program instructions;
a processor, configured to call the program instructions stored in the memory, and perform the steps in the method of any embodiment in the first aspect.

In the fourth aspect, a storage medium is provided, on which computer-executable instructions are stored, the computer-executable instructions are configured to cause a computer to perform the steps in the method of any embodiment in the first aspect.

the advantages of the present disclosure are as follows.

In the embodiments of the present disclosure, the transmission instruction of the to-be-transmitted data can be acquired; the transmission instruction at least carries the to-be-transmitted data, and then the to-be-transmitted data is transferred to the first state according to the transmission instruction when the first slave state machine is determined to transmit the to-be-transmitted data, to transfer the to-be-transmitted data according to the preset transfer state; when it is determined that the clock cycle for transmitting the to-be-transmitted data reaches the preset clock cycle (the eighth clock cycle), the to-be-transmitted data is transferred to the preset state; and if it is determined that the preset transmission time is reached, the to-be-transmitted data is transmitted. That is to say, in the embodiment of the present disclosure, the data transmission can be suspended during the eighth clock cycle, that is, the master state machine is required to take over the control of the data bus in advance, so that no glitch is generated at source, that is, the glitches can be eliminated accurately to improve the accuracy of the data transmission.

### BRIEF DESCRIPTION OF THE DRAWINGS

In order to more clearly describe the technical solution in the embodiments of the present disclosure or the related technology, accompanying drawings needed in the description of the embodiments will be briefly introduced below. Obviously, the drawings in the following description are merely some embodiments of the present disclosure.

FIG. 1 is a schematic diagram of a bus timing sequence of data exchange between a master and a slave in an I2C bus system according to some embodiments of the present disclosure.

FIG. 2 is a schematic structure block diagram of an I2C bus system according to some embodiments of the present disclosure.

FIG. 3 is a schematic diagram of an external connection path of an I2C bus system according to some embodiments of the present disclosure.

FIG. 4 is a flow chart showing a method for eliminating a glitch according to some embodiments of the present disclosure.

FIG. 5 is a state transition diagram of a state machine according to some embodiments of the present disclosure.

FIG. 6 is a schematic diagram illustrating an apparatus for eliminating a glitch according to some embodiments of the present disclosure.

FIG. 7 is a schematic structure block diagram of a state machine according to some embodiments of the present disclosure.

### DETAILED DESCRIPTION

In order to make the objectives, technical solution and advantages of the present disclosure clearer, the technical solution in the embodiments of the present disclosure will be clearly and completely described with reference to the accompanying drawings in the embodiments of the present disclosure. Obviously, the described embodiments are merely some embodiments of the present disclosure, rather than all of the embodiments. Based on the embodiments in the present disclosure, all other embodiments obtained by those of ordinary skill in the art without creative work shall fall within the protection scope of the present disclosure. In the case of no conflict, the embodiments in the present disclosure and the features in the embodiments can be combined with each other arbitrarily. Further, although a logical sequence is shown in the flow chart, in some cases, the steps shown or described may be performed in a different order than here.

The terms “first” and “second” in the specification and claims of the present disclosure and the above-mentioned drawings are utilized to distinguish different objects, rather than to describe a specific sequence. In addition, the term “including” and any transformations of them are intended to cover non-exclusive protection. For example, a process, method, system, product, or device that includes a series of steps or units is not limited to the listed steps or units, but optionally includes unlisted steps or units, or optionally also includes other steps or units inherent to these processes, methods, products or equipment.

In the embodiments of the present disclosure, the term “and/or” in this disclosure is merely an association relationship describing associated objects, which means that there can be three kinds of relationships, for example, A and/or B can mean that single A exists, A and B exist at the same time, and single B exists. In addition, the character “/” in this disclosure, unless otherwise specified, generally indicates that the associated objects are in an “or” relationship.

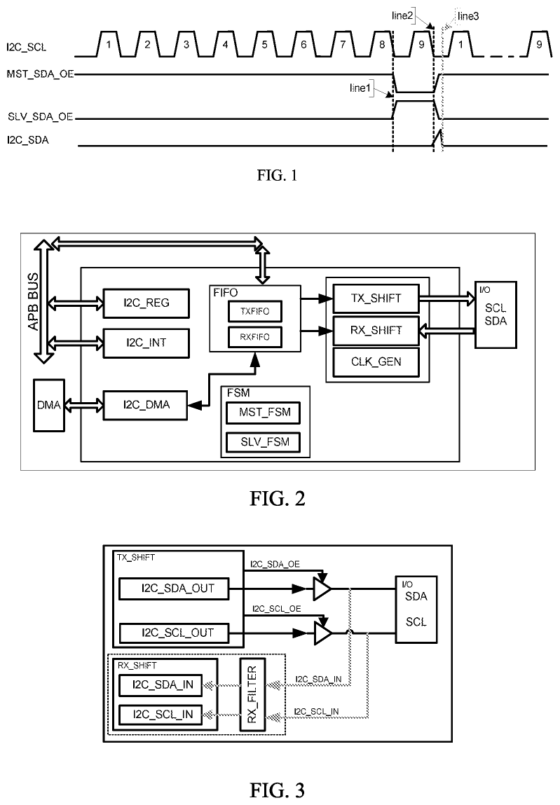

As mentioned earlier, when the I2C bus is utilized to transmit data in the related technology, a glitch problem may occur. For details, please refer to FIG. 1. As shown in FIG. 1, I2C_SCL is set to represent a clock transmission state of the I2C bus; I2C_SDA is set to represent a data transmission state of the I2C bus; MST_SDA_OE is set to represent a data transmission state of a master state machine; and SLV_SDA_OE is set to represent a data transmission state of a slave state machine; line1 represents that the master state machine begins to release a control of the data bus; line2 represents that the slave state machine begins to release the control of the data bus; and line3 represents that the master state machine completes the takeover of the control of the data bus.

Referring to FIG. 1, according to the I2C standard protocol, the master state machine of the I2C bus system starts to release the control of the data bus at a falling edge of a bit8 clock of the I2C_SCL (line1 dotted line), i.e., the eighth clock cycle, and the I2C slave state machine starts to take over the control of the data bus, i.e., starts to transmit data. At a bit9 clock of the I2C_SCL, i.e., the ninth clock cycle, which is a duration of a high level in which the I2C slave state machine takes over the control of the data bus; the dashed line of line2 represents that the I2C slave starts to release the control of the data bus; the I2C master state machine does not completely the takeover of the bus until the dotted line of line3. When the master state machine and the slave state machine do not take over the control of the bus, the control state of the I2C_SDA data bus may be affected by an external pull-up resistor, causing that the I2C_SDA has a glitch on the data bus near the falling edge of the I2C_SCL clock.

In a specific implementation process, in order to facilitate the understanding of the glitch state, please refer to data shown in Table 1:

TABLE 1

| I2C_SDA | I2C_SDA | I2C_SDA | SDA_OE | |
|---|---|---|---|---|
| (bit 9) | (bit 1) | (change) | (change) | performance |
| 0 | 0 | 0→0 | 1→1 | with glitch |
| 0 | 1 | 0→1 | 1→0 | without glitch |
| 1 | 0 | 1→0 | 0→1 | without glitch |
| 1 | 1 | 1→1 | 0→0 | without glitch |

Specifically, referring to Table 1, when data is transmitted through the I2C bus system, the data is generally transmitted in a set of 8 bits. That is to say, when bit9 data is transmitted, the next transmission is for a next set of data. Referring to the Table 1. in the Table 1, “0” is set to indicate a low level, and “1” is set to indicate a high level. When the slave state machine releases the control of the data bus, while the master state machine does not receive the control of the data bus in time, the glitches may appear.

Through the analysis as described above, it can be seen that in the I2C bus system, the ninth clock cycle of I2C_SCL in the transmission circuit of the master state machine, that is, the data bus corresponding to the high level of the ninth clock is 0, and the highest bit of a byte next sent by the master is 0, that is, the glitch is definitely generated near the falling edge of the ninth clock.

In view of this, the present disclosure proposes a method for eliminating a glitch, which can be applied to the I2C bus system, by which the control signal can be combined with the transmission state of the state machine, so that the problem that glitches are prone to appear during the exchange of the control of the data bus between the I2C master and the I2C slave in the ninth clock cycle of the I2C_SCL in the transmission circuit of the I2C master can be solved.

After introducing the design ideas of the embodiments of the present disclosure, the application scenarios to which the technical solution of the method for eliminating the glitch in the embodiments of the present disclosure is applied are briefly introduced. It should be noted that the application scenarios described below are merely utilized to illustrate the embodiments of the present disclosure without limitation. In specific implementation, the technical solution provided by the embodiments of the present disclosure can be flexibly applied according to actual requirements.

Referring to FIG. 2, which is a structure block diagram of an I2C bus system in the present disclosure. Specifically, the I2C bus system includes a data storage module, a first-in first-out module, a data control module, and a data transceiving module. The data storage module will be detailed with reference to FIG. 2. The I2C_REG is set to represent a storage submodule configured to store data; I2C_INT is set to represent a storage submodule configured to store a control signal; I2C_REG and I2C_INT are configured to receive to-be-transmitted data which is sent by an advanced peripheral bus (APB) and interactive data, i.e., a control signal, between the I2C bus system and the APB; a Direct Memory Access (DMA) is configured to connect to the I2C_DMA storage sub-module in the I2C bus system.

In the specific implementation process, the external system bus reads and writes a register by the APB through the I2C bus. When a large number of control commands and data need to be stored in a static random access memory (SRAM) or a synchronous dynamic random access memory (SDRAM), the DMA can be used as a data transmission unit.

Referring to FIG. 2, the I2C_DMA storage submodule, the I2C_REG storage submodule, and the I2C_INT storage submodule are all connected to the First-In First-Out (FIFO) module in the I2C bus system. Then the control commands and data can be transmitted by the data transceiving module in the I2C bus system. The data transceiving module in the I2C bus system includes a TX_SHIFT submodule, a RX_SHIFT submodule and a CLK_GEN submodule. Specifically, the TX_SHIFT submodule is a data transmission submodule; the RX_SHIFT can be a data receiving submodule; and the CLK_GEN submodule is a clock generation submodule.

In the specific implementation process, referring to FIG. 2, the I2C bus system further includes a data control module, that is, a finite state machine (FSM) in FIG. 2 consisting of a state register and a combinational logic circuit, which can transfer the state according to a pre-designed state according to the control signal, and is a control center that coordinates actions of related signals and completes a specified function. In practical applications, FSM is mainly summarized as a Moore state machine and a Mealy state machine. In the present disclosure, the Mealy state machine is taken as an example for description.

In the embodiments of the present disclosure, the aforementioned FSM can be understood as the data control module in the present disclosure. The data control module includes the master state machine and the slave state machine. The state machine module can control the I2C bus system to perform the data transition on the to-be-transmitted data when transmitting the data according to the specified state, in order to implement the control of the time of the data transmission. In such a manner, the generation of glitches can be avoided. In the embodiment of the present disclosure, the state machine module can include multiple slave state machines, which is not limited in the present disclosure.

In the embodiment of the present disclosure, referring to FIG. 3, which is utilized to show a detailed structure diagram illustrating a data transceiving module in FIG. 2 and an external connection circuit. In a specific implementation process, when the to-be-transmitted data needs to be transmitted to outside, the data transmission module and the clock signal generation module in the transmission submodule can be utilized to transmit the to-be-transmitted data in a cycle of a clock signal generated by the clock signal generation module. When data needs to be obtained from the outside, the data can be received by the data transmission module through the I/O interface in accordance with a clock sequence of the clocks generated by the clock signal generation module in the receiving submodule.

The technical solution provided by the embodiments of the present disclosure will be introduced in conjunction with the accompanying drawings of the specification.

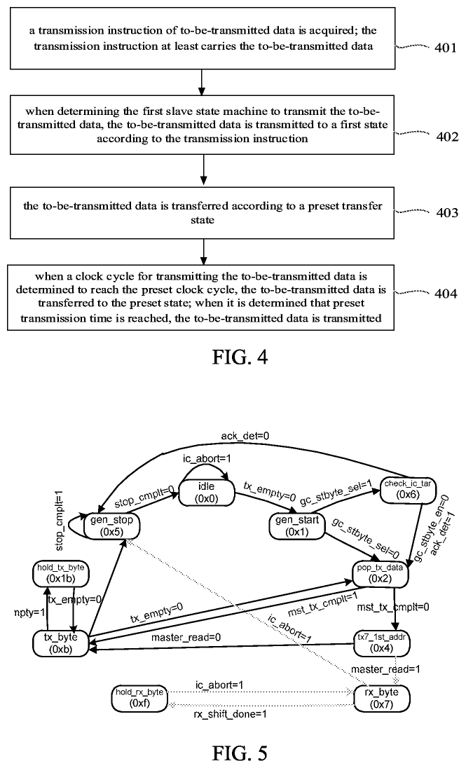

Referring to FIG. 4, in an embodiment of the present disclosure, a method for eliminating a glitch is provided. The method can be performed by the aforementioned state machine. The specific process of the method is described as follows.

Step 401: a transmission instruction of to-be-transmitted data is acquired; the transmission instruction at least carries the to-be-transmitted data.

Step 402: when determining the first slave state machine to transmit the to-be-transmitted data, the to-be-transmitted data is transmitted to a first state according to the transmission instruction.

Step 403: the to-be-transmitted data is transferred according to a preset transfer state.

Step 404: when a clock cycle for transmitting the to-be-transmitted data is determined to reach the preset clock cycle, the to-be-transmitted data is transferred to the preset state; when it is determined that preset transmission time is reached, the to-be-transmitted data is transmitted.

In some embodiments of the present disclosure, the transmission instruction of the to-be-transmitted data is acquired. The transmission instruction at least carries the to-be-transmitted data; and when it is determined that the first slave state machine can transmit the to-be-transmitted data, the data to be transferred is transferred to the first state according to the transmission instruction; and then the to-be-transmitted data is transferred according to the preset transfer state; when the clock cycle for transmitting the data to be transferred is determined to reach the preset clock cycle (the eighth clock cycle), the to-be-transmitted data is transferred to the preset state; and if it is determined that the preset transmission time is reached, the to-be-transmitted data is transmitted. That is to say, in the embodiment of the present disclosure, the data transmission can be suspended during the eighth clock cycle, that is, the master state machine needs to take over the control of the data bus in advance, so that no glitch can be generated at the source, that is, the glitch cane be eliminated accurately to improve the accuracy of data transmission.

Specifically, in order to more clearly illustrate the control of the state machine on the data transmission of the data transceiving module in the embodiment of the present disclosure, so as to implement the technical solution of eliminating the glitch, referring to FIG. 5, the default state of the master state machine starts from a state in which the first-in first-out module has no data input, that is, idle (0x0) shown in FIG. 5; and then when the first-in first-out module is determined to have the data input, that is, when tx_empty=0, the first-in first-out module enters the gen_start state.

In the specific implementation process, it can be based on whether the transmission instruction of the to-be-transmitted data which is transmitted to the gen_start state includes the indication information indicating the slave state machine to transmit the to-be-transmitted data. If the indication information is carried, it is not the general_call mode, i.e., (gc_stbyte_sel=0); the aforementioned general_call mode can be understood as calling all slave state machines, that is, a slave state machine can be determined from at least one slave state machine to process the to-be-transmitted data. Then, in the corresponding non-general_call mode, i.e., there is no need to call all slave state machines, the slave state machine can be determined according to indication information.

Continuously referring to FIG. 5, when the transmission instruction does not carry any indication information, it can be determined to select the general_call mode, i.e., (gc_stbyte_sel=1), and then the check_ic_tat state is entered, that is to say, it is necessary to determine whether at least one slave state machine can transmit the to-be-transmitted data. Then the master state machine writes the address of the to-be-transmitted data into the first-in first-out module, such as 0x00, and transmits the address to all I2C slave state machines. If an I2C slave state machine responds, a response (ack_det=1) is returned to the I2C master state machine, so that the master state machine can determine the first slave state machine from the at least one slave state machine.

In the embodiment of the present disclosure, if the at least one slave state machine cannot transmit the to-be-transmitted data, the to-be-transmitted data is returned to the gen_stop state or idle state, that is, the to-be-transmitted data is regarded as the next to-be-transmitted data or discarded data.

In the embodiment of the present disclosure, after the first slave state machine capable of transmitting the to-be-transmitted data is determined, i.e., the pop_tx_data state, that is, the aforementioned first state, is reached as shown in FIG. 5. Specifically, the pop_tx_data state can be understood as a determination of transmitting the transmission address of the to-be-transmitted data to the slave state machine. When it is determined that the condition of mst_tx_cmplt=1 is satisfied, it means that the master state machine completes the transmission of the address, and the to-be-transmitted data can be determined to enter the tx_byte state, which is the aforementioned completed state of transmission of the storage address of the to-be-transmitted data in the preset state.

In the embodiment of the present disclosure, when the first slave state machine is determined from the non-general_call mode, i.e., (gc_stbyte_sel=0), the control state of the to-be-transmitted data is jumped from the gen_start state to the pop_tx_data state; then when it is determined according to the condition of mst_tx_cmplt=0 that the I2C master needs to transmit the address (tx7_1st_addr) again, because the condition of master_read=0 immediately indicates that the master performs the write operation, i.e., the master is about to enter the state of transmitting data, and then enter the rx_byte state.

In the specific implementation process, when the TX_FIFO, that is, the data in the first-in-first-out module does not follow the transmission rate of the data (tx_empty=1), it is considered that the preset clock cycle is reached, and the preset state is transferred to the hold_tx_byte state, which is the aforementioned preset state. Conversely, if the TX_FIFO, i.e., the date in the first-in-first-out module is synchronized with the transmission rate of the data, that is, the control signal is not received, the to-be-transmitted data is sent to a to-be-transmitted state, that is, the rx_byte state.

In the embodiment of the present disclosure, during the period from tx_empty=1 to tx_empty=0, that is, after entering the hold_tx_byte state but before jumping to the tx_byte state, the I2C data bus may be pulled up by the pull-up resistor because the I2C works in the open_drain mode, so that abnormally raised glitches appear during the I2C_SCL low level.

In the embodiment of the present disclosure, when the preset transmission time is reached, the to-be-transmitted data is jumped from the hold_tx_byte state to the tx_byte state, thereby avoiding the occurrence of glitches on the I2C data bus due to a void connection in the control takeover of the data bus between the master state machine and the slave state machine, which causes the problem of lower transmission accuracy of the to-be-transmitted data.

In the embodiment of the present disclosure, it can be understood that a predictive control bit is added to the hold_tx_byte state. When I2C_SDA_OE is 0 and 1 in bit9 and bit1, respectively, I2C_SDA may have a glitch, and the I2C master state machine is required to take over the control of the data bus in advance, that is, when the control signal is received, i.e., when the preset transmission time is reached, the master state machine takes over the control of the data bus.

Further, in the embodiment of the present disclosure, the gray_code (Gray code) can be utilized to encode the first slave state machine, for example, from the tx_byte state to the hold_tx_byte state, the corresponding code is jumped from 0xb to 0x1b.

As mentioned above, in some embodiments, a coding format of the slave state machine that is determined to process the to-be-transmitted data is in the coding format of the Gray code. In this case, since there is only a change of 1 bit data, the slave state machine has an adaptive ability compared to the conventional I2C slave state machine. That is, the slave state machine can automatically determine whether to allow the I2C master state machine to take over the bus in advance according to a different transmission data hardware, which can reduce the power consumption of the I2C bus system.

The circuit design of the glitch adaptive state machine in the embodiment of the present disclosure, that is, the aforementioned method for eliminating the glitch, can fundamentally reduce the possibility of generation of the glitch during the bus interaction process between the I2C master state machine and the I2C slave state machine; and since the first slave state machine is coded by using the Gray code, in such a manner, the power consumption of jumping between the states can be reduced, the stability of the system is enhanced, and the anti-interference ability is improved. For example, when four pieces of data are transmitted, there is a 3/4 probability that the state machine jumps according to the Gray code. Compared to the technical solution in the related technology, the power consumption of the jumping of the state machine is reduced by at least 50%, and the number of the slave state machines adopted is small.

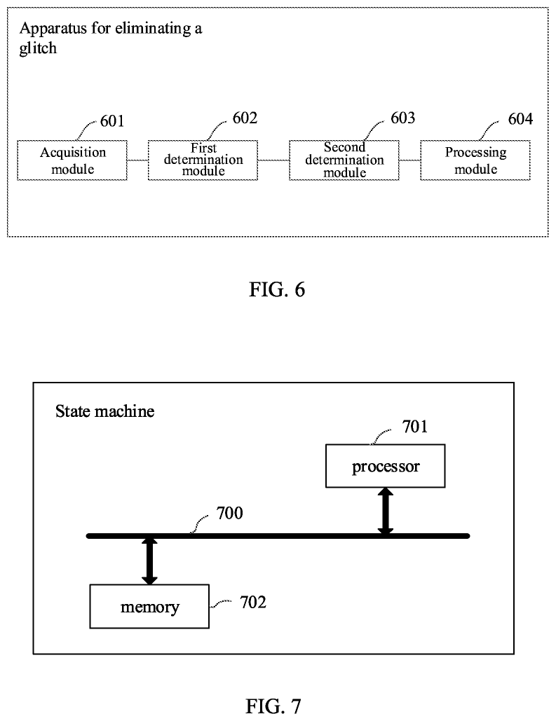

Based on the same inventive concept, in embodiments of the present disclosure, an apparatus for eliminating a glitch is provided, which can implement the functions corresponding to the aforementioned method for eliminating the glitch. The apparatus for eliminating the glitch can be a hardware structure, a software module, or a hardware structure in combination with a software module. The apparatus for eliminating the glitch can be implemented by a chip system which may consist of a chip, or may include a chip and other discrete devices. Referring to FIG. 6, the apparatus for eliminating the glitch includes an acquisition module 601, a first determination module 602, a second determination module 603, and a processing module 604.

The acquisition module 601 is configured to acquire a transmission instruction of to-be-transmitted data; the transmission instruction at least carries the to-be-transmitted data.

The first determination module 602 is configured to transmit the to-be-transmitted data to a first state according to the transmission instruction when determining the first slave state machine to transmit the to-be-transmitted data.

The second determination module 603 is configured to transfer the to-be-transmitted data according to a preset transfer state; the preset transfer state at least includes a completed state of a transmission of a storage address of the to-be-transmitted data, and a read state of the to-be-transmitted data.

The processing module 604 is configured to transfer the to-be-transmitted data to the preset state when determining that a clock cycle for transmitting the to-be-transmitted data reaches a preset clock cycle, the preset state being a state of suspended data transmission, and transmit the to-be-transmitted data when determining that preset transmission time is reached.

In an optional embodiment, the first determination module 602 is configured to:
when the transmission instruction is determined to include indication information indicating a first slave state machine to transmit the to-be-transmitted data, determine the indicated first slave state machine from at least one slave state machine according to the indication information to transmit the to-be-transmitted data to the first state.

In an optional embodiment, the first determination module 602 is configured to:
determine at least one slave state machine to transmit the to-be-transmitted data;
transmit the to-be-transmitted data to the first state when the first slave state machine is determined from the at least one slave state machine to transmit the to-be-transmitted data.

In an optional embodiment, when the to-be-transmitted data cannot be transmitted by the at least one slave state machine, the to-be-transmitted data is taken as the next to-be-transmitted data or discarded data.

In an optional embodiment, the second determination module 603 is configured to:
determine whether a control signal is received when determining that the to-be-transmitted data is transmitted to the first state;
transfer the to-be-transmitted data to the preset state when determining that the control signal is received. In an optional embodiment, when it is determined that no control signal is received, the address information of the to-be-transmitted data is read, and the to-be-transmitted data is transmitted to a to-be-transmitted state.

In an optional embodiment, the coding mode of the first slave state machine is a gray_code coding mode.

All relevant content of the steps involved in the foregoing embodiments of the method for eliminating the glitch can be cited in the functional description of the function modules corresponding to the apparatus for eliminating the glitch in the embodiment of the present disclosure, and will not be repeated here.

The division of modules in the embodiments of the present disclosure is illustrative, and is merely a logical function division. In actual implementation, there may be other division modes. In addition, the function modules in the various embodiments of the present disclosure may be integrated into one processor, or can exist separately physically; or two or more modules can be integrated into one module. The above-mentioned integrated modules can be implemented in the form of hardware or software function modules.

Based on the same inventive concept, in an embodiment of the present disclosure, a state machine is provided. As shown in FIG. 7, the state machine includes at least one processor 701 and a memory 702 connected to the at least one processor. The embodiment of the present disclosure does not limit the specific connection medium between the processor 701 and the memory 702. In FIG. 7, the connection between the processor 701 and the memory 702 through the bus 700 is taken as an example. The bus 700 is represented by a thick line in FIG. 7; and the connection modes between other components are merely for schematic illustration and is not meant to limit. The bus 700 can be summarized as an address bus, a data bus, a control bus, etc. For ease of presentation, only one thick line is used in FIG. 7 to represent the bus, but it does not mean that there is only one bus or one type of bus.

In some embodiments of the present disclosure, the memory 702 stores instructions that are executed by at least one processor 701, and the at least one processor 701 executes the steps in the aforementioned method for eliminating the glitch by executing the instructions stored in the memory 702.

In some embodiments, the processor 701 is the control center of the state machine, which uses various interfaces and lines to connect the various parts of the entire state machine. By running or executing instructions stored in the memory 702 and calling data stored in the memory 702, various functions and processing data of the state machine, to monitor the state machine as a whole. In some embodiments, the processor 701 may include one or more processing units; and the processor 701 may integrate an application processor and a modem processor. The application processor mainly processes an operating system, a user interface, and application programs, etc. The modem processor mainly deals with wireless communication. It can be understood that the foregoing modem processor may not be integrated in the processor 701. In some embodiments, the processor 701 and the memory 702 may be implemented on the same chip; while in some embodiments, they may also be implemented respectively on separate chips.

The processor 701 may be a general-purpose processor, such as a central processing unit (CPU), a digital signal processor, an application-specific integrated circuit, a field programmable gate array or other programmable logic devices, discrete gates or transistor logic devices, discrete hardware components, which can implement or execute the methods, steps, and logical block diagrams disclosed in the embodiments of the present disclosure. The general-purpose processor may be a microprocessor or any conventional processor or the like. The steps of the method disclosed in the embodiments of the present disclosure may be directly embodied as executed and completed by a hardware processor, or executed and completed by a combination of hardware and software modules in the processor.

In some embodiments, the memory 702, as a non-transitory computer-readable storage medium, is configured to store non-transitory software programs, non-transitory computer-executable programs, and modules. The memory 702 may include at least one type of storage medium, for example, may include flash memory, hard disk, multimedia card, card-type memory, Random Access Memory (RAM), Static Random Access Memory (SRAM), Programmable Read Only Memory (PROM), Read Only Memory (ROM), Electrically Erasable Programmable Read-Only Memory (EEPROM), magnetic memory, disk, CD, etc. The memory 702 is any other medium that can be configured to carry or store desired program codes in the form of instructions or data structures and that can be accessed by a computer, but is not limited thereto. The memory 702 in the embodiment of the present disclosure may also be a circuit or any other device capable of realizing a storage function, and is configured to store program instructions and/or data.

By designing and programming the processor 701, the code corresponding to the method for eliminating the glitch introduced in the foregoing embodiment can be solidified into the chip, so that the chip can execute the steps of the method for eliminating the glitch when operating. How to deal with the design and programming of the processor 701 is a technology well known to those skilled in the art, and will not be repeated here.

Based on the same inventive concept, in an embodiment of the present disclosure, a storage medium is further provided, which stores computer instructions, and the computer instructions, when executed on a computer, execute the steps of the aforementioned method for eliminating the glitch.

In some optional embodiments, the various aspects of the method for eliminating the glitch provided in the present disclosure may also be implemented in the form of a program product, which includes a program code. When the program product operates on a state machine, the program code is configured to make the state machine execute the steps in the method for eliminating glitch according to various exemplary embodiments of the present disclosure described above in this specification.

Those skilled in the art should understand that the embodiments of the present disclosure can be provided as a method, a system, or a computer program product. Therefore, the present disclosure may adopt the form of a complete hardware embodiment, a complete software embodiment, or an embodiment combining software and hardware. Moreover, the present disclosure may take the form of a computer program product implemented on one or more computer-usable storage media (including but not limited to a disk storage, an optical storage, etc.) containing computer-usable program codes.

The present disclosure is described with reference to flow charts and/or block diagrams of methods, apparatus (systems), and computer program products according to embodiments of the present disclosure. It should be understood that each process in the flow chart and/or a block in the block diagram, and the combination of processes in the flow chart and/or blocks in the block diagram can be implemented by computer program instructions. These computer program instructions can be provided to the processor of a general-purpose computer, a special-purpose computer, an embedded processor, or other programmable data processing equipment to generate a machine, so that the instructions executed by the processor of the computer or other programmable data processing equipment produce an apparatus that implements the functions specified in one process or multiple processes in the flow chart and/or one block or multiple blocks in the block diagram.

These computer program instructions can also be stored in a computer-readable memory that can direct a computer or other programmable data processing equipment to work in a specified mode, so that the instructions stored in the computer-readable memory produce an article of manufacture including the instruction apparatus. The instruction apparatus implements the functions specified in one process or multiple processes in the flow chart and/or one block or multiple blocks in the block diagram.

These computer program instructions can also be loaded on a computer or other programmable data processing equipment, so that a series of operation steps are executed on the computer or other programmable equipment to produce computer-implemented processing, so that the instructions executed on the computer or other programmable equipment provide steps for implementing functions specified in a flow or multiple flows in the flow chart and/or a block or multiple blocks in the block diagram.

Obviously, those skilled in the art can make various modifications and variations to the present disclosure without departing from the spirit and scope of the present disclosure. In this way, if these modifications and variations of the present disclosure fall within the scope of the claims of the present disclosure and their equivalent technologies, the present disclosure is also intended to include these modifications and variations.

1. A method for eliminating a glitch, applied to an I2C bus, the method comprising:
acquiring a transmission instruction of to-be-transmitted data, wherein the transmission instruction at least carries the to-be-transmitted data;
transmitting the to-be-transmitted data to a first state according to the transmission instruction when determining a first slave state machine to transmit the to-be-transmitted data;
transferring the to-be-transmitted data according to a preset transfer state; the preset transfer state at least comprises a completed state of a transmission of a storage address of the to-be-transmitted data, and a read state of the to-be-transmitted data;
transferring the to-be-transmitted data to a preset state when determining that a clock cycle for transmitting the to-be-transmitted data reaches a preset clock cycle, the preset state being a state of suspended data transmission, and transmitting the to-be-transmitted data when determining that preset transmission time is reached.

2. The method according to claim 1, wherein, the transmitting the to-be-transmitted data to the first state according to the transmission instruction when determining the first slave state machine to transmit the to-be-transmitted data comprises:
when the transmission instruction is determined to comprise indication information indicating the first slave state machine to transmit the to-be-transmitted data, determining the indicated first slave state machine from at least one slave state machine according to the indication information to transmit the to-be-transmitted data to the first state.

3. The method according to claim 1, wherein, the transmitting the to-be-transmitted data to the first state according to the transmission instruction when determining the first slave state machine to transmit the to-be-transmitted data comprises:
determining at least one slave state machine to transmit the to-be-transmitted data;
transmitting the to-be-transmitted data to the first state when determining the first slave state machine from the at least one slave state machine to transmit the to-be-transmitted data.

4. The method according to claim 3, wherein when the to-be-transmitted data cannot be transmitted by the at least one slave state machine, taking the to-be-transmitted data as next to-be-transmitted data or discarded data.

5. The method according to claim 1, wherein the transferring the to-be-transmitted data according to the preset transfer state comprises:
determine whether a control signal is received when determining that the to-be-transmitted data is transmitted to the first state;
transferring the to-be-transmitted data to the preset state when determining that the control signal is received.

6. The method according to claim 5, wherein, when determining that no control signal is received, reading address information of the to-be-transmitted data, and transmitting the to-be-transmitted data to a to-be-transmitted state.

7. The method according to claim 1, wherein a coding mode of the first slave state machine is a gray_code coding mode.

8. An apparatus for eliminating a glitch, applied to an I2C bus, the apparatus comprising:
an acquisition module, configured to acquire a transmission instruction of to-be-transmitted data; the transmission instruction at least carries the to-be-transmitted data;
a first determination module, configured to transmit the to-be-transmitted data to a first state according to the transmission instruction when determining the first slave state machine to transmit the to-be-transmitted data;
a second determination module, configured to transfer the to-be-transmitted data according to a preset transfer state; the preset transfer state at least comprises a completed state of a transmission of a storage address of the to-be-transmitted data, and a read state of the to-be-transmitted data;
a processing module, configured to transfer the to-be-transmitted data to the preset state when determining that a clock cycle for transmitting the to-be-transmitted data reaches a preset clock cycle, the preset state being a state of suspended data transmission, and transmit the to-be-transmitted data when determining that preset transmission time is reached.

9. A state machine, comprising:
a memory, configured to store program instructions;
a processor, configured to call the program instructions stored in the memory, and perform the steps in the method of claim 1 according to the acquired program instructions.

10. A storage medium, on which computer-executable instructions are stored, wherein the computer-executable instructions are configured to cause a computer to perform the steps in the method of claim 1.
